(19) United States
(12) Patent Application Publication
(10) Pub. No.: US 2010/0269032 A1
(43) Pub. Date: Oct. 21, 2010

(54) ADVANCED TEXT COMPLETION, SUCH AS FOR MARKUP LANGUAGES

(75) Inventors: Jefferson King, Bellevue, WA (US); Alexander N. Gavrilov, Snoqualmie, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/423,827

(22) Filed: Apr. 15, 2009

(51) Int. Cl. G06F 17/21; G06F 9/44; G06F 17/00

(52) U.S. Cl. 715/234; 717/114; 715/261

(57) ABSTRACT

A text completion system is described herein that completes text at a tag and/or attribute level based on a syntactic understanding of software program code. The system includes sets of elements and associated attribute-value pairs that represent interesting, common, and repeated patterns. As a user is editing a web page or other document in an editing tool that implements the system, the user can retrieve, select, and insert these patterns using simple commands. The system receives a selected pattern from the user, and inserts target text associated with the pattern. In addition, users can fill in instance-specific data within the larger pattern to allow a single pattern to cover several common and closely related scenarios. Thus, the text completion system increases user productivity by providing more intelligent text completion through a syntactic understanding of the language in which a document is written.

### BACKGROUND

Document editing tools often offer text completion features that allow an author to type a small amount of text, such as the beginning of a word, and insert a larger amount of text. For example, Microsoft Word includes AutoCorrect, which authors can use to store whole paragraphs of text that authors can insert by typing a single word or string of characters. For example, type the text “copyright” might insert a standard copyright disclaimer for a law office. Similarly, software development tools, such as Microsoft Visual Studio, provide the ability to view words that begin with typed letters as the developer types one or more letters. For example, Microsoft Visual Studio includes IntelliSense, which collects symbols by compiling an application program and enumerating a tree representation of the application program's source code. As the user types the first letters of a symbol, the user can press Tab or another key to insert the full text of the symbol.

Many languages, such as markup languages, are very verbose in that authors type a lot of text to express relatively straightforward concepts. For example, Hypertext Markup Language (HTML) includes beginning and ending tags for each markup element, (e.g., <italics> and </italics>). These tags only get longer as web developers include more advanced functionality on web pages, such as objects (e.g., ActiveX or other controls). Tags may start with common text, and include multiple attributes and sub-elements that describe the object that the page invokes. For example, invoking an object for displaying a video may include the markup “<object classid=“clsid:22D6F312-B0F6-11D0-94AB-0080C74C7E95”> <param name=“FileName” value=“3d.wmv”/></object>.” A developer creating a web page retypes the same text repeatedly, and text completion is of little help when, for example, only the value “3d.wmv” changes for each video instance.

The problem with most existing document editing tools with text completion is that the text completion is typically token-based, looking at the first few letters of the text the user types to determine what text to insert. For markup languages, many tags may start with the same text, rendering token-based completion virtually useless. For example, in HTML the object tag may be used to invoke thousands of different objects, each with its own set of attributes and sub-elements. Editing applications that simply insert a block of text to replace a small string of text typed by the author ignore the subtleties of the markup language and the fact that often the author is only concerned with modifying a single attribute or two. For authors, the repeated typing of text produces low productivity, increases psychological tedium, and may produce errors or cause the author to have to memorize arcane and lengthy element and attribute names and values to perform relatively simple tasks.

### SUMMARY

A text completion system is described herein that completes text at a tag and/or attribute level based on a syntactic understanding of software program code, thereby increasing developer productivity. The system includes sets of elements and associated attribute-value pairs that represent interesting, common, and repeated patterns. As a user is editing a web page or other document in an editing tool that implements the system, the user can retrieve, select, and insert these patterns using simple commands. When the user loads a document, the system scans one or more pattern files and loads shortcuts associated with each pattern. As the user is typing, the system may filter the list of available shortcuts based on the context of the current cursor location. The system receives a selected pattern from the user, and inserts target text associated with the pattern. In addition, users can fill in instance-specific data within the larger pattern to allow a single pattern to cover several common and closely related scenarios. Thus, the text completion system increases user productivity by providing more intelligent text completion through a syntactic understanding of the language in which a document is written.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the text completion system, in one embodiment.

FIG. 2 is a flow diagram that illustrates the processing of the system to prepare to use patterns in response to a user opening a document for editing, in one embodiment.

FIG. 3 is a flow diagram that illustrates the processing of the system to complete text for a user based on one or more text patterns, in one embodiment.

### DETAILED DESCRIPTION

A text completion system is described herein that completes text at a tag and/or attribute level based on a syntactic understanding of software program code, thereby increasing developer productivity. Using the text completion system, a user defines sets of elements and associated attribute-value pairs that represent interesting, common, and repeated patterns. The system may also provide a set of predefined patterns for the user to select. As the user is editing a web page or other document in an editing tool that implements the system, the user can retrieve, select, and insert these patterns using simple commands that do not detract from the original workflow. For example, the user can insert patterns while typing without using the mouse or invoking a dialog or menu. When the user loads a document, the system scans one or more pattern files and loads shortcuts associated with each pattern. For example, a shortcut may start with the element name for a particular HTML tag. As the user is typing, the system may filter the list of available shortcuts based on the context of the current cursor location. For example, if the cursor is within a tag, the system may offer attribute completion patterns but not tag completion patterns.

The system receives a selected pattern from the user, and inserts target text associated with the pattern. For example, the user may type a tag name and press the Tab or other key to invoke a pattern with a shortcut associated with that tag name. The system may post-process the inserted text based on preferences of the user. For example, the user may prefer self-closing tags (e.g., <tag/>) to open and close tags (e.g., <tag></tag>) and the system may modify the target text inserted by the pattern based on these user preferences. In addition, users can fill in instance-specific data within the larger pattern to allow a single pattern to cover several common and closely related scenarios. For example, a pattern may include a tag with an attribute that is a color, so that sometimes the user sets the color to “blue” and other times to other colors. Thus, the text completion system increases user productivity by providing more intelligent text completion through a syntactic understanding of the language in which a document is written.

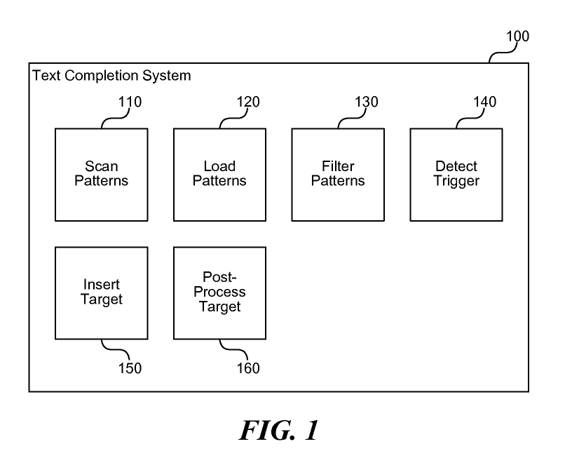

FIG. 1 is a block diagram that illustrates components of the text completion system, in one embodiment. The system 100 includes a scan patterns component 110, a load patterns component 120, a filter patterns component 130, a detect trigger component 140, an insert target component 150, and a post-process target component 160. Each of these components is described in further detail herein.

The scan patterns component 110 loads one or more stored patterns from a data store or other nonvolatile memory. For example, the system may store patterns as XML files or in a database, and enumerate each available pattern for loading into memory. Each pattern may contain information such as a name of the pattern, the author, one or more shortcuts that a user can type to invoke the pattern, the pattern target (i.e., snippet) to insert when the pattern is invoked, and so forth. The scan patterns component 110 may operate to load patterns when a user opens an editing application or a document to preload the available patterns into memory for quick access when a user types a pattern shortcut. Although the system 100 may cache the content of patterns, the system may also monitore the pattern store for user updates and reload the cache if an update is detected. For example, a user may edit a pattern file, add or delete new patterns, and so forth. The next time the user invokes a completion list and/or inserts the pattern, the user will see any new patterns.

The load patterns component 120 receives enumerated patterns from the scan pattern component 110 and loads each pattern shortcut into a list or other collection of words or characters that a user can type to cause the system to insert additional text into a document. For example, Microsoft IntelliSense provides an extensible completion list of shortcuts that a user can type while editing a document to insert various text into the document. The patterns provided by the system 100 may supplement other shortcuts (e.g., based on a lexical understanding of the document language) already provided by the editing application.

In some embodiments, the system 100 includes a filter patterns component 130 that filters patterns presented to the user based on information about the site of insertion. For example, some tags may not be valid based on the current location of the cursor. The filter patterns component 130 can eliminate invalid or otherwise inapplicable patterns from the list of available patterns to present the user with a smaller and more relevant list of patterns that the user may want to insert. The system 100 may receive a notification from the editing application when the application is about to display a dialog of available shortcuts or completion strings. In response to the notification, the filter patterns component 130 can remove or hide any inapplicable patterns based on the current context (e.g., cursor location, highlighted text, and so forth).

The detect trigger component 140 determines when the user has invoked a pattern by typing or selecting the pattern's trigger. For example, each pattern may include one or more shortcut words or characters that the user can type to insert the target text of that particular pattern. The detect trigger component 140 may receive notification from the editing application as the user types so that the system 100 can identify invoked triggers or the editing application may perform these steps internally and provide the system 100 with a notification when a user has invoked a specific pattern. Those of ordinary skill in the art will recognize various common ways of detecting that a user has typed particular text or invoked a particular shortcut. When the detect trigger component 140 detects a shortcut, the component 140 invokes the insert pattern target component 150 to insert the target text associated with the pattern.

The insert target component 150 inserts target text of a pattern in response to the detect trigger component 140 detecting that a user has invoked a particular pattern. Patterns may contain wildcards or variables that the insert target component 150 fills in based on the context of the pattern invocation. For example, a particular pattern may operate for multiple shortcuts and the pattern target text may include a wildcard that the system fills in with the particular shortcut that caused the current invocation of the pattern. Other wildcards may include inserting text selected at the time of the pattern invocation and other variable information that the insert target component 150 can retrieve from the editing application or other components.

The post-process target component 160 modifies the target text of the invoked pattern based on user preferences or other information. For example, although a pattern contains target text that may be generic for all users, a particular user may have preferences regarding the formatting of markup tags, how text is indented, and so forth that the system 100 enforces for patterns as well. The post-process target component 160 applies these preferences to the inserted target text to carry out the user's preferences.

The computing device on which the text completion system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

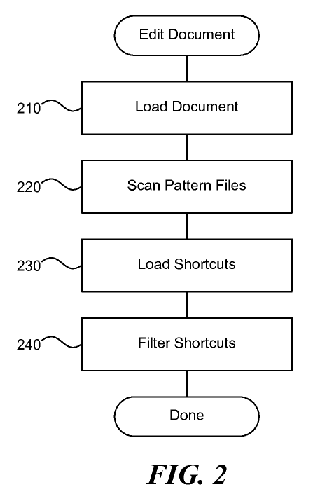

FIG. 2 is a flow diagram that illustrates the processing of the system to prepare to use patterns in response to a user opening a document for editing, in one embodiment. Beginning in block 210, the system loads a document or receives notification that an editing application has loaded a document. Typically, the system is incorporated in an editing application, either directly or as an add-in, and works closely with the application to implement the techniques described herein. When the editing application loads or opens a document, the application can provide a notification that allows the system to perform startup tasks, such as pre-caching patterns. Continuing in block 220, the system scans one or more stored patterns to identify a shortcut word or characters that trigger each pattern and the type of markup represented by the pattern. A pattern may represent an element, attribute, plain text, or other parts of a markup document. The system caches the identified information for later use. By performing this work in advance, the system takes care of the relatively expensive operation of scanning pattern files to avoid performing the operation when a user later invokes the system to insert text, thereby providing a faster response to the user.

Continuing in block 230, the system loads the identified shortcuts or triggers into a completion list or similar structure of the editing application. For example, the editing application may already provide token-level text completion, such as Microsoft IntelliSense, and the system adds the additional pattern shortcuts to the existing completion list. The base completion list may represent a list of values valid to be inserted at the current caret position. To seamlessly integrate a choice of patterns, the system may merge all appropriate pattern definitions (keyed by shortcut string) into this list. Continuing in block 240, the system optionally filters the patterns in the completion list. The system determines the appropriateness of each pattern based on the current location by comparing the target text of each pattern with the valid tokens for the current caret location. If a pattern contains target text that is valid for the current location, then the pattern is valid for the current location and the system enables the pattern's shortcut to be active in the completion list. Otherwise, the system may disable or remove the pattern shortcut from the completion list to narrow the list displayed or available to the user to those most relevant for the current context. This query, filter, and merge operation is quick because of the earlier cached pattern data. After block 240, these steps conclude.

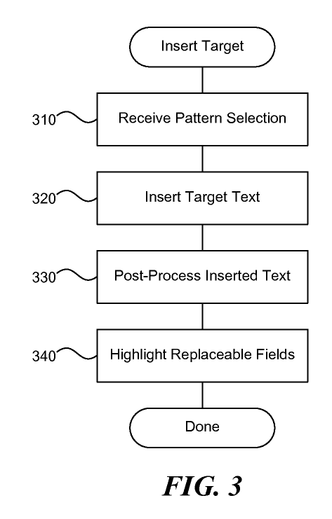

FIG. 3 is a flow diagram that illustrates the processing of the system to complete text for a user based on one or more text patterns, in one embodiment. Beginning in block 310, the system receives an indication that the user has selected a particular pattern. For example, the user may type a trigger or shortcut word, receive a user interface with a choice of several patterns that the user may want to use, and make a selection (e.g., based on the user pressing the Tab or other key) of a particular pattern. The system receives a notification indicating the pattern that the user selected or invoked. Continuing in block 320, the system inserts target text associated with the selected pattern into a displayed text buffer. For example, if the user selects a pattern with target text that specifies an HTML object tag, then the system inserts the target text at the cursor location. The target text goes beyond traditional token level replacement and may include inserting markup begin and end tags, surrounding existing selected text with text inserted before and after the selected text, inserting various tag attributes, and so forth.

Continuing in block 330, the system post-processes the inserted text to conform to one or more preferences set by the user. For example, the user may have preferences related to whether the editing application indents statements with tabs or spaces, how object identifiers are determined, and so forth. The target text in the pattern file may not conform to a particular user's preferences, so post-processing ensures that inserted pattern text adheres to the user's specified preferences. Continuing in block 340, the system highlights fields that the user can replace in the inserted text. For example, a pattern target may specify one or more default attribute values or one or more empty attribute values that vary enough to make pre-filling the values inappropriate in the pattern itself. Thus, the next thing that a user may want to do after inserting a pattern is to specify appropriate values for these attributes. The system may highlight the attributes (e.g., using a distinguished text color, background color, boldface font, or other attention-getting indication that the fields are replaceable) so that the user knows to pay further attention to the attributes. The system may allow the user to use the Tab or other key to navigate between replaceable fields. When the user is satisfied with the inserted pattern text, the user can press a key (e.g., Enter) or provide another indication to commit the pattern and store the text in the document. In some embodiments, the pattern may contain an end token (e.g., “$end$”) that defines where the system places the cursor after the pattern is committed. This further facilitates streamlined and unobtrusive document editing. The user may be able to avoid this behavior by committing the pattern using Escape or a different key. After block 340, these steps conclude.

In some embodiments, the text completion system stores patterns with multiple trigger words. With markup languages, it is common to have nearly identical patterns that only vary by one or a few words. Rather than storing each such pattern separately, the system allows these patterns to be stored as a single pattern that is triggered by multiple words. In addition, the word that triggered the pattern can be referenced as a replaceable value within the pattern. For example, if two tags, tag1 and tag2, share 10 similar attribute values when they are used, then tag1 and tag2 may be trigger words for a pattern that inserts whichever of the two tags triggered the pattern along with default values for the 10 attributes. The following illustrates an example pattern file with multiple triggers. In this example, the pattern file is stored in XML, although many other storage paradigms can be used.

```
<CodeSnippet Format=“1.1.0”
xmlns=“http://schemas.microsoft.com/VisualStudio/2005/CodeSnippet”>
  <Header>
    <Title>div</Title>
    <Author>Microsoft Corporation</Author>
    <Shortcut>div</Shortcut>
    <AlternativeShortcuts>
      <Shortcut>p</Shortcut>
      <Shortcut>h1</Shortcut>
      <Shortcut>h2</Shortcut>
      <Shortcut>h3</Shortcut>
      <Shortcut>h4</Shortcut>
      <Shortcut>h5</Shortcut>
      <Shortcut>h6</Shortcut>
      <Shortcut>blockquote</Shortcut>
      <Shortcut>pre</Shortcut>
      <Shortcut>address</Shortcut>
      <Shortcut>center</Shortcut>
      <Shortcut>noscript</Shortcut>
    </AlternativeShortcuts>
    <Description>Markup snippet for a block element</Description>
    <SnippetTypes>
      <SnippetType>Expansion</SnippetType>
      <SnippetType>SurroundsWith</SnippetType>
    </SnippetTypes>
  </Header>
  <Snippet>
    <Code Language=“html”>
        <![CDATA[<$shortcut$>$selected$$end$</$shortcut$>]]>
    </Code>
  </Snippet>
</CodeSnippet>
```

In this example, the pattern is contained within an opening and closing “CodeSnippet” tag. Within these tags, the pattern contains a “Header” and a “Snippet.” The header specifies metadata information about the pattern and the snippet specifies the target text for the pattern. The header contains information such as a title for the pattern, the pattern's author, one or more shortcuts that invoke the pattern, a description of the pattern's purpose, and a type of the pattern (e.g., related to how it inserts text). The target text may include variables that the system fills in while inserting the text. For example, in the sample pattern above the target text contains a variable “$shortcut$” that specifies the identity of the shortcut that invoked the pattern in the current instance. This particular pattern inserts similar text for many shortcuts to represent common markup block elements (e.g., paragraph tags, header tags, and so forth). When the user begins typing any one of these tags, the pattern can insert opening and closing tags, the specified language attribute, and so forth. By storing what would otherwise be multiple patterns in this way, the text completion system makes it easier and faster for the user to create multiple related patterns, increases the ease of maintenance of the patterns, and reduces the disk and memory footprint used to store patterns.

The tag-level completion performed by the text completion system can apply to many languages. Although HTML has been used as one example, the system can also be used with JavaScript, XML, CSS, and other languages that benefit from text completion beyond simple token-level completion. In some embodiments, the text completion system provides a user interface, such as a dialog box, through which users can manage existing and create new patterns. For example, the system may provide a dialog or property sheet that integrates with a settings user interface of the editing application to provide configuration of the behavior and contents of the system.

In some embodiments, the text completion system displays an indication to users that differentiates patterns from other items in the completion list displayed as the user types. For example, the system may identify patterns with an icon or other visual indicator, so that users can differentiate patterns from tag-level completion shortcuts.

In some embodiments, the text completion system retrieves information for filtering patterns from the stored information about a pattern. For example, using the sample XML pattern file above, the “Code” element could contain a “Kind” attribute that specifies whether the pattern applies at the element, attribute, or other level. When the insertion point or cursor is already within an element (e.g., a tag), then the system may display attribute patterns but not element patterns, for example. In addition, the system may filter available patterns based on the semantics of the document language. For example, for an HTML document the system would not display a “HEAD” tag pattern when the cursor is currently within the “BODY” tag, since that is invalid HTML. In some embodiments, the stored pattern may override this behavior, such as by including a “Key” attribute on the “Code” element described herein. The key attribute may include a wildcard (e.g., asterisk) to apply in all contexts or a specific string to override any heuristically determined key. Alternatively or additionally, the text completion system may automatically determine the level at which a pattern applies (e.g., Kind=“Auto”) based on heuristics. For example, if the pattern contains an opening angle bracket, text, and a closing angle bracket, then the system may assume that the content of the target is a markup tag (e.g. <tag>xyz</tag>). On the other hand, if the pattern contains a word, an equals sign, and another word, then the system may assume that the content of the target is an attribute (e.g., color=“blue”).

In some embodiments, the text completion system provides advanced keyboard navigation so that a user can insert pattern in the flow of typing without using the mouse or selection mechanisms (e.g., a menu item). For example, when user types a pattern shortcut and presses the Tab key, the system may insert the pattern target text. If the user again presses the Tab key, the system may insert default attribute values or child elements and supply an end tag. These and other keyboard shortcuts increase the user's productivity.

In some embodiments, the text completion system is user extensible so that users can create and add new patterns. The system may include certain predefined patterns and users may discover additional patterns that would be helpful for document creation and editing. For example, a user may commonly use an HTML control that the user custom developed or bought from a third party, and may want to include an OBJECT or other tag pattern that quickly inserts tags and attribute values commonly inserted to use the control.

In some embodiments, the text completion system inserts multiple tags when triggered by a single tag shortcut. For example, a pattern based on a table tag in HTML may include a trigger for the word “table” but may insert a TABLE tag, one or more row or column tags (e.g., TD and TR), table heading tags (e.g., TH), and so forth. The system provides the user with a level of completion based on the semantics and common usage of particular markup language elements not possible with previous text completion systems.

In some embodiments, the text completion system provides a user interface for disambiguation of patterns with similar triggers. It is possible that a user has multiple triggers for similar tags used in different situations. For example, the user may have a pattern for inserting a video into a web page and a pattern for inserting a list control that both use the HTML OBJECT tag and have a trigger of “object.” When the user inputs the trigger and invokes the system, the system recognizes that multiple patterns are present for the trigger and presents a user interface, such as an inline list control, from which the user can resolve the ambiguity of which pattern the user wants to insert. The user can scroll within the list of available options and select the appropriate pattern. The system inserts the target text for the pattern selected by the user.

In some embodiments, the text completion system provides a facility for patterns to specify functions that are evaluated during text replacement. It is common in markup language, particularly for web pages, to have multiple tags that reference a control on the page by identifier. For example the markup “<asp:Button ID=“MyCoolButton” runat=“server” Text=“Click Me!”/>” defines a button with an identifier “MyCoolButton.” A pattern may include a function that the system evaluates and the system may place the result in a replacement field. For example, a pattern may include a “PreviousControlID” function that causes the system to scan the document backwards at a potential pattern insertion point, find the first control tag, and use the identifier of that control as the value of the function. This and other useful functions can be added to the system to further increase document editing efficiency.

From the foregoing, it will be appreciated that specific embodiments of the text completion system have been described herein for purposes of illustration, but that various modifications may be made without deviating from the spirit and scope of the invention. For example, although markup language has been described, the system can also be used with other languages that are syntactically verbose. Accordingly, the invention is not limited except as by the appended claims.

I/We claim:

1. A computer-implemented method for providing text completion shortcuts within a document, the method comprising:
receiving a notification that an editing application has loaded a document, wherein the document is associated with a particular programming language;
scanning one or more stored patterns to identify a shortcut word or characters that trigger each pattern and the type of text represented by the pattern;
loading the identified shortcuts into a completion list of the editing application that specifies shortcuts that a user can type to insert target text of the one or more patterns;
for each shortcut in the completion list, determining whether target text of a pattern associated with the shortcut is valid at a current insertion position based on the programming language associated with the document; and
filtering the patterns in the completion list based on whether the pattern is valid at the current insertion point, wherein the preceding steps are performed by at least one processor.

2. The method of claim 1 wherein receiving a notification comprises registering for the notification and receiving the notification from the application in response to a user creating a new document or modifying an existing document.

3. The method of claim 1 wherein the type of text represented by the pattern determines whether the text corresponds to a markup element or attribute.

4. The method of claim 1 further comprising caching the results of scanning one or more stored patterns and using the cached results in response to a user request to insert a pattern.

5. The method of claim 1 wherein the completion list contains shortcuts for token-level completion and markup tag-level completion.

6. The method of claim 1 wherein filtering the patterns comprises accessing a previously cached list of patterns to determine the target text for each pattern.

7. A computer system for reducing the amount of text typed by a user to compose a document, the system comprising:
a processor and memory configured to execute software instructions;
a scan patterns component configured to load one or more stored patterns from a data store;
a load patterns component configured to receive enumerated patterns from the scan pattern component and load one or more shortcuts associated with each pattern into a collection of words or characters that a user can type to cause the system to insert additional text into the document;
a detect trigger component configured to determine that the user has invoked a pattern by selecting the pattern's shortcut; and
an insert target component configured to insert target text of a pattern in response to the detect trigger component detecting that a user has invoked the pattern.

8. The system of claim 7 wherein the data store accessed by the scan patterns component includes one or more XML files, each XML file containing one or more pattern definitions.

9. The system of claim 7 wherein the data store contains information about each pattern including a name of the pattern, one or more shortcuts that a user can type to invoke the pattern, and target text to insert after the pattern is invoked.

10. The system of claim 7 wherein the scan patterns component is invoked by an editing application in response to a user opening a document and wherein the scan patterns component preloads available patterns into memory for quick access in response to a user typing a pattern shortcut.

11. The system of claim 7 wherein the patterns provided by the system through the load patterns component supplement other shortcuts already in the list provided by an editing application.

12. The system of claim 7 further comprising a filter patterns component configured to filter patterns presented to the user based on information about a current cursor position.

13. The system of claim 12 wherein the filter patterns component is further configured to filter patterns based on whether each pattern target is valid for a language of the document at the current cursor position.

14. The system of claim 12 wherein the filter patterns component is further configured to receive a notification from an editing application before the application displays available patterns to the user.

15. The system of claim 7 wherein the detect trigger component detects that the user has selected a trigger in response to the user typing the trigger and pressing a key.

16. The system of claim 7 wherein the insert target component is further configured to identify one or more wildcards in a pattern definition and fill in the one or more wildcards based on a current context under which the pattern is invoked.

17. The system of claim 7 further comprising a post-process target component configured to modify the inserted target text of the invoked pattern based on user preferences.

18. A computer-readable storage medium comprising instructions for controlling a computer system to complete text in a document, wherein the instructions, when executed, cause a processor to perform actions comprising:
receiving an indication that a user has selected a pattern that specifies target text to replace shortcut text entered by the user;
inserting the target text associated with the selected pattern into a displayed text buffer, wherein the displayed text buffer represents the contents of the document, and wherein the document is a markup language document;
post-processes the inserted text to conform to one or more preferences set by the user; and
highlighting one or more fields that the user can replace in the inserted text, wherein the highlighted fields represent one or more values in the inserted text that may change based on a particular use of the pattern.

19. The medium of claim 18 wherein receiving an indication that the user has selected the pattern comprises displaying a user interface to the user containing a list of available patterns and receiving a selection from the user of a pattern from the list.

20. The medium of claim 18 wherein inserting the target text comprises inserting an opening tag, closing tag, and at least one attribute of a markup language element.
